(19) United States
(12) Patent Application Publication
(10) Pub. No.: US 2006/0161620 A1
(43) Pub. Date: Jul. 20, 2006

(54) Extensible activities within collaboration sessions

(75) Inventors: Krishnamurthy Ganesan, Redmond, WA (US); Mu Han, Redmond, WA (US); Adrian Potra, Issaquah, WA (US)

Correspondence Address: PERKINS COIE LLP/MSFT, P. O. BOX 1247, SEATTLE, WA, 98111-1247, US

(73) Assignee: Microsoft Corporation, Seattle, WA (US)

(21) Appl. No.: 11/026,554

(22) Filed: Dec. 30, 2004

(51) Int. Cl. G06F 15/16; G06F 17/00; G06F 3/00; G06F 9/00

(52) U.S. Cl. 709/204; 715/751; 709/201

(57) ABSTRACT

An architecture for developing new media activities and deploying the newly developed activities in a reusable collaboration session is provided. The architecture comprises a base collaboration session, a base activity class, and a well defined contract between the base activity class and the collaboration session. The base collaboration session provides signaling plane functionality, including session management services and media negotiation services. The base activity class provides the base class support needed to build or develop activities derived from the base activity class. The well defined contract enables the base activity class and the base collaboration session to work together to hide the details of the signaling plane from the derived activities.

### TECHNICAL FIELD

The described technology is directed generally to data communications and, more particularly, to an architecture for an extensible collaboration session.

### BACKGROUND

Efficient communication and collaboration among members of an organization is critical to the organization's success. Among organization members, face-to-face meetings have been the traditional manner of communicating, but, with the organizations becoming increasing geographically dispersed, these meetings often require travel on the part of attendees and, thus, are becoming increasingly cost prohibitive. The proliferation of computers and the advent of the Internet, and in particular, the maturing of the World Wide Web (“web”), has brought about a number of alternatives to the traditional face-to-face meeting.

Various collaboration applications and protocols enable communications between software programs or users. As examples, real-time collaboration applications such as MICROSOFT WINDOWS MESSENGER and Voice over Internet Protocol (“VoIP”) enable communications between users sending each other text, video, or voice data. These applications may use various protocols, such as Session Initiation Protocol (“SIP”), Real-Time Transport Protocol (“RTP”), and Real-Time Control Protocol (“RTCP”), to establish sessions and send communications-related information. SIP is an application-layer control protocol that devices can use to discover one another and to establish, modify, and terminate sessions between devices. RTP is a protocol for delivering audio and video over the Internet, and is frequently used in streaming media systems and videoconferencing systems in conjunction with other protocols such as SIP and H.323. RTCP is a protocol that enables a client application to monitor and control data sent or received using RTP, and is used with RTP. SIP and RTP/RTCP are IETF proposed standards. Their specifications, “RFC 3261” and “RFC 3550,” and respectively, are available on the Internet at www.ietf.org at/rfc/rfc3261.txt and www.faqs.org at/rfcs/rfc3550.html, respectively, and are incorporated herein in their entirety by reference.

Collaboration systems which provide collaboration applications or media activities such as instant messaging, audio video, live webconferencing, screen and document sharing, etc., are being increasingly used as a less expensive alternative to the traditional face-to-face meeting. Although these media activities enable multiple collaborators or participants to share information without requiring them to be physically co-located, each of the activities are difficult to develop in that they require the logic for both the specific activity and the signaling. Stated another way, each activity needs to provide not only the logic for its specific media activity but also needs to provide the logic to perform the communication between the participants who are using the activity.

Thus, one drawback is that application developers are required to become familiar with details of each of the many communications protocols they use in media activities they develop. By way of example, to provide a videoconferencing activity in an application, not only would the application's developer need to provide the videoconferencing logic, the application's developer would also have to become familiar with a number of protocols, such as SIP and RTP/RTCP, and provide logic to coordinate these protocols to add videoconferencing capabilities. An application developer not familiar with all of the necessary protocols may need additional training and time to become familiar with these protocols.

Furthermore, because each media activity provides both the media logic and the signaling logic, a collaboration session established between participants using an instance of the activity is not extensible. Stated another way, each activity requires the creation and establishment of its own collaboration session. A drawback is that as new media activities are designed and added to the collaboration system, the existing collaboration sessions are not reusable with the new media activities.

### BRIEF DESCRIPTION OF THE DRAWINGS

FIG. 1 is a block diagram illustrating selected components typically incorporated in at least some of the computer systems on which the architecture may be implemented.

FIG. 2 is a block diagram illustrating selected components of an architecture for an extensible activities within collaboration sessions, according to some embodiments.

FIG. 3 is a block diagram illustrating a plurality of activities derived from a base activity class, according to some embodiments.

FIG. 4 is a block diagram illustrating an example collaboration session object, according to some embodiments.

FIG. 5 is a block diagram illustrating relationships between a CEP and a plurality of collaboration session objects, according to some embodiments.

FIG. 6 illustrates a flow chart of a method by which a CEP creates a collaboration session object, according to some embodiments.

FIG. 7 illustrates a flow chart of a method by which a collaboration session object creates an activity object, according to some embodiments.

### DETAILED DESCRIPTION

In some embodiments, an architecture for developing new media activities and deploying the newly developed activities in a reusable collaboration session is provided. The architecture provides components and a high-level application program interface (“API”) for writing media activities that derive from a base activity, and implementing collaboration sessions that are reusable with a new media activity or activities.

The architecture comprises a base collaboration session, a base activity class, and a well defined contract between the base activity class and the collaboration session. The architecture utilizes concepts from object oriented programming and provides one or more APIs that an application developer can use to access and provide functionality provided by the collaboration session and the base activity class, as well as other architecture components.

The base collaboration session generally provides session management services, such as signaling. The collaboration session takes care of call control, such as establishing a session, inviting new participants into the session, controlling the session, exposing a roster of participants of the session, and the like. The collaboration session also provides media negotiation, such as media bandwidth, selection of codec to use to compress and decompress audio or video data, and other media parameters. The base collaboration session also has specific knowledge of the activity or activities that may be supported in a collaboration session.

The architecture supports the creation of multiple instances of the base collaboration session, and each collaboration session instance serves as a container for an activity or multiple activities as well as providing the session management services for the contained activity or multiple activities. Stated another way, each collaboration session instance represents a collaboration session between one or multiple participants using the activity or multiple activities contained in the particular collaboration session instance.

The base activity class provides a facility for building or developing derived activity classes. New activity classes, such as instant messaging, teleconferencing, videoconferencing, webconferencing, application sharing, AudioVideo, and other activities, derive from the base activity class. The base activity class serves as an interface to the functions and features provided by the collaboration session, in that the subclass of the base activity, i.e., the derived activity, does not interact directly with the collaboration session. Rather, the derived activity interacts with the collaboration session by utilizing the exposed base activity class methods and properties.

As an example of the extensibility of the base activity class, an application developer can use the APIs to develop an activity depending on—e.g., derived from—the base activity class and supply the newly created activity to the API so that an instance of the base collaboration session can create an instance of the new activity type. In this manner, the new activity instance is created in the collaboration session instance. The activity typically uses a media stack. If there are multiple participants in the session represented by the collaboration session instance, there is an instance of the media stack representing the activity, for example, at each of the participants' computer system. These media stacks may need to communicate with each other to set up transport and select media parameters. For example, an AudioVideo activity might require an exchange of codec information to decide which codec to use. The collaboration session provides and offers the ability to perform this media negotiation to the activities by exposing the provided functions via the base activity class. In addition to media negotiation, the activity class provides a roster of participants participating in an activity using the collaboration session. The activity can use the roster information to expose, for example, via an API, an activity specific roster, such as a list of instant messaging participants or AudioVideo participants.

The well defined contract between the base activity class and the collaboration session generally refers to the knowledge the base activity class has of the collaboration session, and vice versa. The collaboration session deals with the signaling plane and the base activity class to provide the base class support needed for any activity. The well defined contract allows the collaboration session and the base activity class to work together to hide many of the details from the specific activities.

A technical advantage is that the architecture separates the signaling plane and the media plane to allow innovation to happen in these planes independently. The collaboration session and the base class activity provide the bridge needed for these two planes to exchange well defined data.

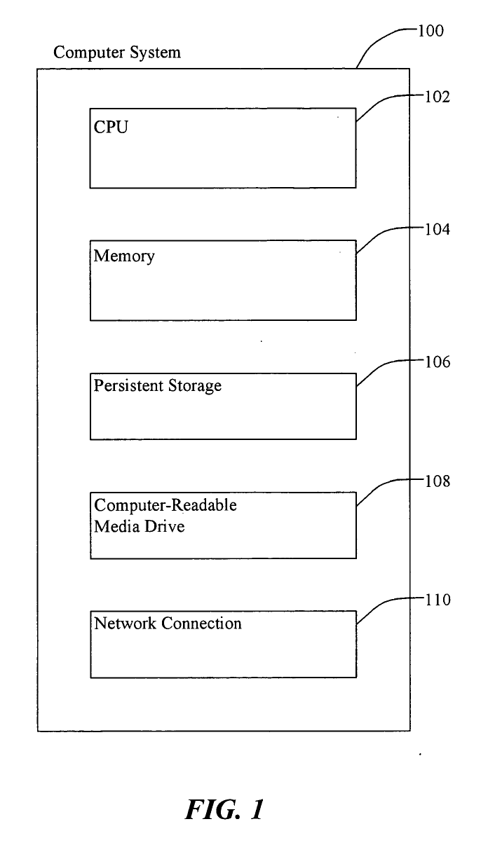

The architecture and its advantages are best understood by referring to FIGS. 1-7 of the drawings. The elements of the drawings are not necessarily to scale, emphasis instead being placed upon clearly illustrating the principles of the invention. Throughout the drawings, like numerals are used for like and corresponding parts of the various drawings.

In the discussion that follows, various embodiments of invention are further described in conjunction with a variety of illustrative examples. It will be appreciated that the embodiments of invention may be used in circumstances that diverge significantly from these examples in various respects.

FIG. 1 is a block diagram illustrating selected components typically incorporated in at least some of the computer systems on which the architecture may be implemented. These computer systems 100 may include one or more central processing units (“CPUs”) 102 for executing computer programs; a computer memory 104 for storing programs and data—including data structures—while they are being used; a persistent storage device 106, such as a hard drive, for persistently storing programs and data; a computer-readable media drive 108, such as a CD-ROM drive, for reading programs and data stored on a computer-readable medium; and a network connection 110 for connecting the computer system to other computer systems, such as via the Internet, to exchange programs and/or data-including data structures.

The architecture may be described in the general context of computer-readable instructions, such as program modules, executed by computer systems 100 or other devices. Generally, program modules include routines, programs, objects, components, data structures, etc. that perform particular tasks or implement particular abstract data types. Memory 104 and persistent storage device 106 are computer-readable media that may contain instructions that implement the architecture. It will be appreciated that memory 104 and persistent storage 106 may have various other contents in addition to the instructions that implement the facility.

It will be appreciated that computer systems 100 may include one or more display devices for displaying program output, such as video monitors or LCD panels, and one or more input devices for receiving user input, such as keyboards, microphones, or pointing devices such as a mouse. While computer systems 100 configured as described above are typically used to support the operation of the architecture, it will be appreciated that the architecture may be implemented using devices of various types and configurations, and having various components.

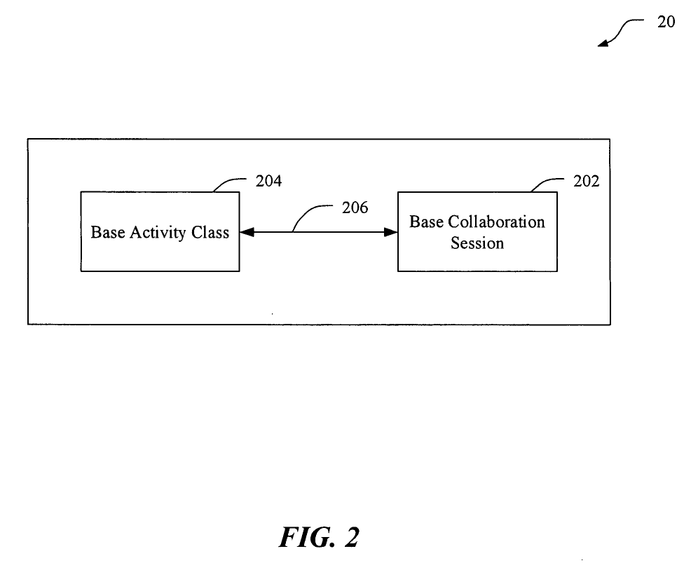

FIG. 2 is a block diagram illustrating selected components of an architecture 20 for an extensible activities within collaboration sessions, according to some embodiments. As depicted, architecture 20 comprises a base collaboration session 202, a base activity class 204, and a specific contract 206 between base activity class 204 and base collaboration session 202. A media activity application may utilize the architecture by accessing the various methods, properties, and events relating to the architecture. For example, an application developer may utilize the architecture by using the provided APIs to write a media activity application that derives from the base activity class. To “plug in” or include the new media activity in a collaboration session, the application developer can supply the new media activity application to the API so that the collaboration session can create an instance of the new media activity.

The base collaboration session provides media activity applications the ability to conduct multi-party, multi-modal sessions. The base collaboration session may be instantiated multiple times and each instance of the collaboration session may provide a “signaling” interface which may be comprised of methods, events and properties relating to controlling signaling of collaboration session endpoints and collaboration session instances. For example, the signaling interface may provide an application the ability to create a collaboration session instance, register to receive notification of changes to a collaboration session instance, create an instance of an activity in a collaboration session instance, invite or request another collaboration session instance to conduct or create an instance of an activity, invite new participants into a collaboration session instance, participate in or leave a collaboration session instance, participate in or leave an instance of an activity in a collaboration session instance, retrieve the current list of participants in a collaboration session instance, retrieve the list of activities in a collaboration session instance, and other signals. In addition, the collaboration session may also provide applications the ability to send and receive transaction messages relating to negotiating, for example, media parameters such as frames per second, which coded to use, etc. In some embodiments, the base collaboration session supports various signaling protocols, including SIP. In other embodiments, other protocols suitable for providing the necessary signaling may be supported by the base collaboration session. Collaboration session endpoints (CEPs) are further discussed below.

In one embodiment, an application uses the API provided by the architecture to create an instance of the base collaboration session, and enters the instance of the collaboration session prior to using the collaboration session instance to invite new participants. On the participant end, an incoming collaboration session needs to be accepted prior to the application participating in the collaboration session instance.

In general terms, base activity class 204 functions as a “bridge” between media activities derived from the base activity class and the collaboration session. Stated another way, the base activity class enables a derived activity—i.e., media plane—and the collaboration session—i.e., the signaling plane—to exchange well defined data. The base activity class provides the base class support needed for any media activity. The base activity class works with the collaboration session to hide the signaling details from the media activities derived from the base activity class. The base activity class provides APIs that enable a media activity derived from the base activity class—i.e., a subclass—to communicate with the collaboration session. For example, the base activity class may offer the subclass media negotiation using the signaling plane. The media negotiation may use some media-agnostic parameters, such as duration of the activity or other media-agnostic data, and/or media specific parameters, such as codecs available.

In some embodiments, the base activity class may provide a media activity application—i.e., a derived class or subclass—the ability to determine a list of participants involved in the signaling plane for that activity. Stated another way, the base activity class may provide the media activity the ability to determine the roster for that activity—i.e., the roster of participants participating in that activity. Each participant may have associated a state indicating whether the participant is “being connected,” “connected,” “leaving,” etc.

The base activity class may provide the derived class the ability to register its delegates—e.g., methods—to handle media negotiation. In one embodiment, the base activity class may require the derived class to register three delegates to handle media negotiations as follows: a GetMediaOffer; a GetMediaAnswer; and a SetMediaAnswer. The GetMediaOffer delegate is invoked when the signaling plane requires an offer from the activity. The GetMediaAnswer delegate is invoked when the signaling plane requires an answer from the activity. The SetMediaAnswer delegate is invoked when the signaling plane received an answer for an offer made previously by the activity.

The base activity class may also provide the derived class the ability to initiate renegotiation of media description exchange by calling a ReNegotiate method. A call to ReNegotiate eventually results in GetMediaOffer and then SetMediaAnswer, for example, when the answer from the remote side is received.

The base activity class may provide the derived class the ability to indicate its preference order of the required signaling topology. In one embodiment, the base activity class may provide three modes to indicate the preference order of the signaling topology as follows: a NoMcu; a McuHost; and a McuGuest. In NoMcu mode, the base activity class provides the activity the ability to exchange media description with every participant in the session. This may be implemented by a full mesh signaling topology. In McuHost mode, the base activity class provides the activity to serve as client side Mcu, in which case every other participant is to exchange media description only with the local participant. This may be implemented by a star shaped signaling topology with the center of the star being represented by the local participant. In McuGuest mode, the base activity class may provide the activity to communicate only with an MCU, where the MCU is either chosen by the signaling plane or explicitly identified by the activity. A multipoint control unit (MCU) normally refers to the server that supports multiple people to have, for example, a video conference.

The collaboration session considers the preference list in creating the signaling topology and responds with the mode chosen. One skilled in the art will appreciate that the signaling plane topology need not necessarily match the topology for the media plane. However, it is beneficial for the media negotiation pattern to match the media topology.

Specific contract 206 between the base activity class and the collaboration session generally refers to knowledge these two classes—i.e., base activity class and collaboration session class—have of one another. Stated another way, the specific contract or well defined contract between the two classes means that the two classes know each other well and rely on unexposed methods to coordinate work, and allows a subclass of the base activity class to not communicate directly with the collaboration session class, but to communicate with the collaboration session class through the base activity class. For example, a derived class may call a method, for example, SendMessage provided by the base activity class API to send a message on the signaling plane. In response, the base activity class may call another method on the collaboration session to send the message. The method invoked on the collaboration session to send the message may be visible only to the base activity class and not to the derived class.

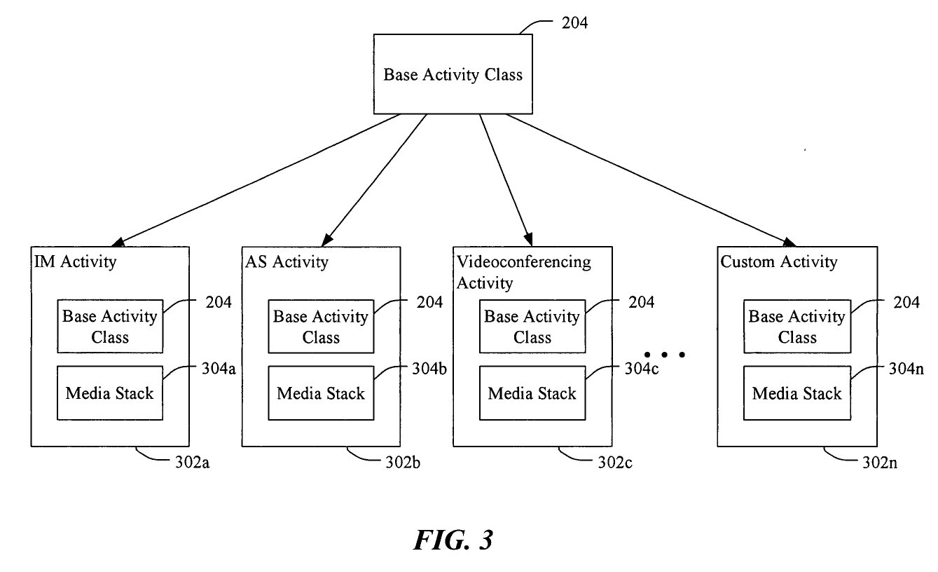

FIG. 3 is a block diagram illustrating a plurality of activities derived from the base activity class, according to some embodiments. As depicted, activities 302a-n are each derived from base activity class 204 and are provided use of the base activity class methods and properties to provide functionality which enables its user, such as an application or another user, to participate in a particular activity, such as, by way of example, AudioVideo, application sharing, instant messaging, teleconferencing, videoconferencing, webconferencing, application sharing, etc. As such, each derived activity utilizes the signaling and other services provided by the base activity class from which it derives, and typically utilizes a media stack that represents the activity. A media stack provides content communication services, such as handling data streams, and may provide an API that is specific to the particular activity to enable other applications or objects to, for example, send or receive the data. For example, for an AudioVideo application, the media stack may be Real-Time Transport Protocol (RTP)/Real-Time Control Protocol (RTCP), and the activity may provide an AddAudio method through its API.

By way of example, four activities derived from the base activity class are illustrated. An IM activity 302a provides instant messaging capabilities which enable users at different computing devices to collaborate by exchanging messages with one another. The derived IM activity includes the base activity class from which it is derived and a media stack 304a. The media stack for the IM activity may be implemented using Message Session Relay Protocol (MSRP).

An AS activity 302b provides application sharing capabilities which enable users at different computing devices to collaborate by sharing applications between one another. For example, two users may share a “whiteboard” application, for example, using which a user can provide visual information that the other user can view and manipulate. The derived AS activity includes the base activity class from which it is derived and a media stack 304b. The media stack for the AS activity may be implemented using Remote Desktop Protocol (RDP).

A videoconferencing activity 302c provides videoconferencing capabilities which enable users at different computing devices to collaborate by sending and receiving audiovisual information. The derived videoconferencing activity includes the base activity class from which it is derived and a media stack 304c. The media stack for the videoconferencing activity may be implemented using RTP/RTCP.

A custom activity 302n is a contemplated media activity. Each custom activity is derived from the base activity class and, thus, includes the base activity class and a media stack 304n that is specific for the custom activity.

A technical advantage provided by the architecture is the framework for extensibility provided by the base activity class. For example, to develop a new derived activity from the base activity class, an application developer would only need to provide the media-specific logic and a suitable media stack, and utilize the API provided by the base activity class to perform the necessary signaling. The application developer need no longer worry about developing the signaling logic. Moreover, changes to the media logic can be readily implemented without impacting the signaling logic, and vise versa.

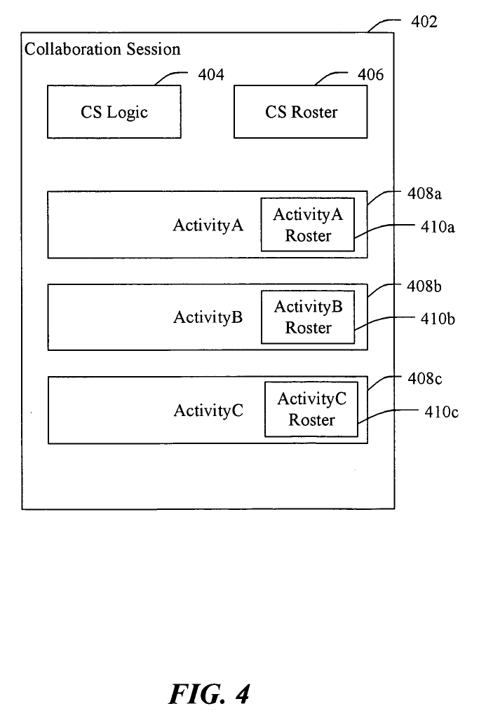

FIG. 4 is a block diagram illustrating an example collaboration session object, according to some embodiments. As depicted, collaboration session object 402 comprises a cs logic 404, a cs roster 406, and zero, one or more activity objects. By way of example, collaboration session object 402 is depicted as comprising three activity objects 408a-c, each comprising an activity roster 410a-c, respectively.

The collaboration session object is an instance of the base collaboration session. The collaboration session object includes or has access to the methods and properties of the base collaboration session and, thus, generally functions to coordinate the creation and use of an activity or activities by the participants of the session. In addition, the collaboration session object comprises instance specific data, for example, which captures its state, thus enabling the collaboration session represented by the collaboration session object to operate on the instance specific state (or data).

The cs logic is the logic which enables the collaboration session object to provide the session management services, call control, media negotiation, activity container services, etc. The cs roster provides a list of participants who are participating in one or more of the activities contained in the collaboration session. For example, in the example collaboration session object depicted in FIG. 4, the cs roster provides a list of participants who are participating in at least one of ActivityA, ActivityB or ActivityC, which are contained in the collaboration session.

The activity objects are each an instance of an activity derived from the base activity class. Each of the activity objects are created by the collaboration session object to which the activity object belongs. The collaboration session object on a computing system has specific knowledge of the activities that are supported on the computing system, thus enabling the collaboration session object to create an instance of one or more of the activities that it has knowledge of. Moreover, the collaboration session object can remove an activity object, thus causing the removed activity to no longer be contained in the collaboration session. In some embodiments, to include an activity in a specific collaboration session, an application creates or identifies the activity and passes the activity to the collaboration session object, which causes the collaboration session object to create or add the activity object to the collaboration session. Thus, the collaboration session objects are reusable in that activity objects can be readily added to and removed from any of the collaboration session objects.

The activity roster provides a list of participants who are participating in the activity associated with the activity roster. For example, ActivityA Roster provides a list of participants who are participating in ActivityA, ActivityB Roster provides a list of participants who are participating in ActivityB, and ActivityC Roster provides a list of participants who are participating in ActivityC.

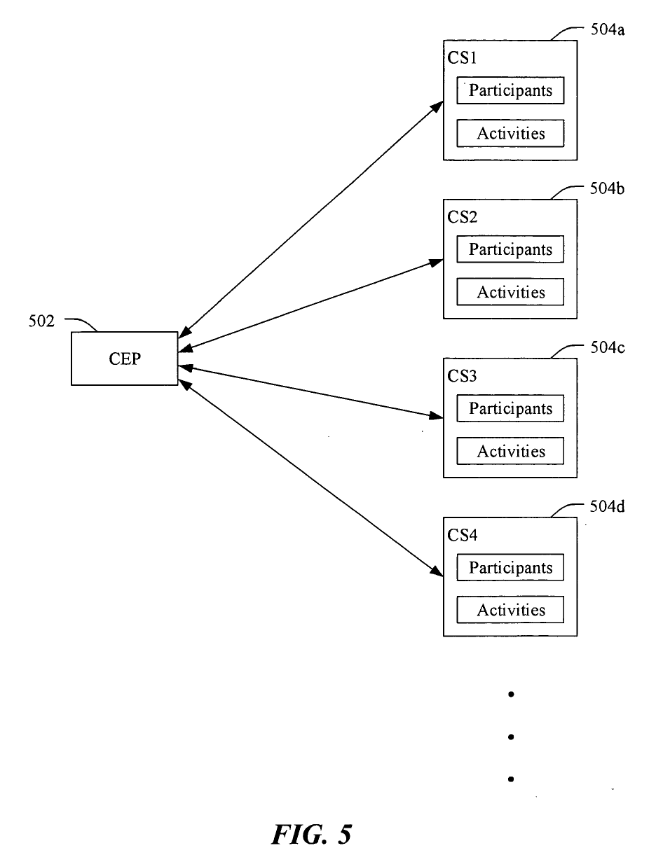

FIG. 5 is a block diagram illustrating relationships between a CEP object 502 and a plurality of collaboration session objects 504a-d, according to some embodiments. As depicted, CEP object 502 is tied to collaboration session objects 504a-d. The number of collaboration session objects depicted is not a limit or restriction on the number of collaboration session objects that may be tied to any one CEP object, and the CEP object may be tied to a different number of collaboration session objects.

In general terms, the CEP object is the entry point to all the collaboration features, such as presence, contacts/groups, pending subscribers, IM, etc., and is created by an application. The CEP object is the addressable entity in the communications cloud. The application first has to “new” a CEP object, and configure the address before it can communicate with other people/applications. The CEP object can be used with a server, such as MICROSOFT LIVE COMMUNICATIONS SERVER, or without a server, for example, in a peer-to-peer mode. In the instances where the CEP object is used with a server, the CEP object permits the application to register with the server so that messages from other endpoints can be routed to this CEP object.

The CEP can be uniquely identified by a combination of a uniform resource locator (URI) and an endpoint identifier (EID). Using such a combination enables the EID to particularly distinguish an instance of an endpoint from another instance of an endpoint that is associated with the same URI. For example, a user can have one CEP on a laptop computer, and another CEP on a handheld computer. The user may also have multiple CEPs on the same computer.

The CEP facilitates the registration of new activities by providing a mechanism for the application to register new activities that can be created by the collaboration session objects. In some embodiments, the base activity class exposes a method that may be used to indicate whether an incoming media description can or cannot be handled by the activity. When creating an activity to handle an incoming session, the collaboration session object iterates through the registered activities to determine which activities need to be created.

The CEP is capable of exposing incoming collaboration sessions. This allows the Applications to register an event callback for incoming session notifications. Further, as depicted in FIG. 5, each collaboration session created by, for example, the application is tied to or associated with a single CEP.

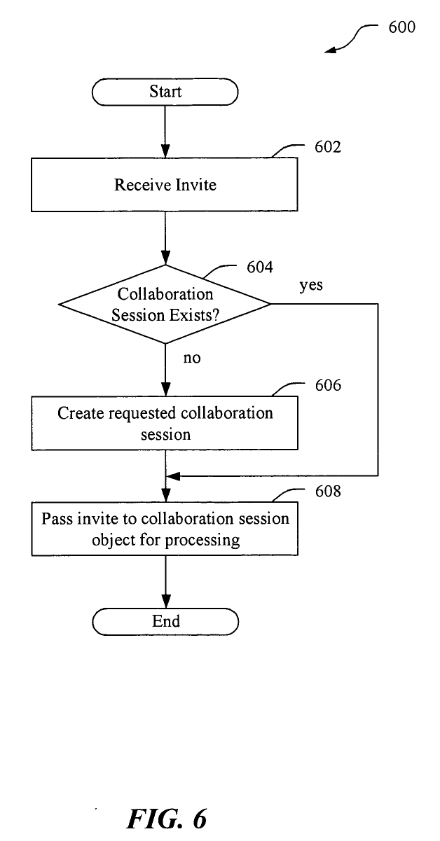

FIG. 6 illustrates a flow chart of a method 600 by which a CEP object creates a collaboration session object, according to some embodiments. Beginning at a start step, the CEP object receives an invite Session Description Protocol (SDP), an IETF proposed standard as specified in RFC 2327, message from, for example, a remote endpoint or CEP object, at step 602. The SDP message includes information such as a session name, a description of the session's purpose, the times the session is active, the media description comprising the session, information to receive the media, etc.

At step 604, the CEP object checks to determine whether an instance of the session specified in the SDP message received in step 602 currently exists. If the session specified in the invite message does not currently exist, then, at step 606, the CEP object creates a collaboration session for the specified session. In some embodiments, the created collaboration session object is tied or linked to the CEP object.

If the CEP object determines that a collaboration session object corresponding to the specified session currently exists (step 604), or subsequent to creating the collaboration session object for the specified session, the CEP object, at step 608, passes the invite SDP message to the collaboration session object for processing, and ends processing. The collaboration session object then proceeds to process the invite SDP message by, for example, sending an answer to the invite.

One skilled in the art will appreciate that, for this and other processes and methods disclosed herein, the functions performed in the processes and methods may be implemented in differing order. Furthermore, the outlined steps are only exemplary, and some of the steps may be optional, combined with fewer steps, or expanded into additional steps without detracting from the essence of the invention.

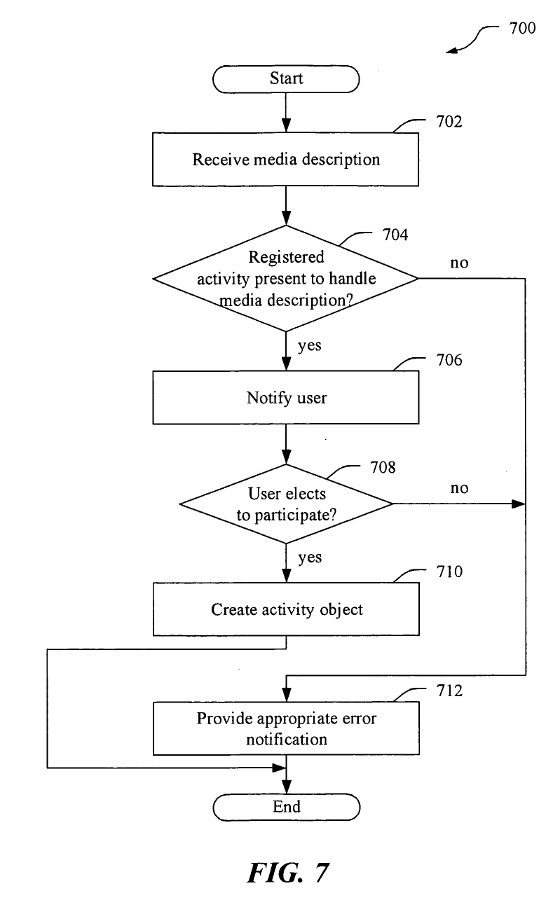

FIG. 7 illustrates a flow chart of a method 700 by which a collaboration session object creates an activity object, according to some embodiments. Beginning at a start step, a collaboration session object receives a media description at step 702. For example, the media description may be included in an invite SDP message.

At step 704, the collaboration session object checks to determine whether there is a registered activity that is capable of “handling” the media description. Stated another way, the collaboration session checks to determine whether there is a registered activity corresponding to the media described by the media description. If an activity that is capable of handling the media description is not available, then, at step 712, the collaboration session object provides an appropriate error notification, and ends processing. For example, the collaboration session object may send an SDP message informing of the inability to support the requested media.

If, at step 704, the collaboration session object determines that there is a registered activity that is capable of handling the media description, then, at step 706, the collaboration session object notifies a user. For example, the collaboration session object may display a notification of the request to participate in the media activity in a window on the user's display device. In some embodiments, a collaboration session object may provide its user the ability to register to receive notifications of events, such as changes to the status of activity objects contained in the collaboration session object. At step 708, the collaboration session object checks to determine whether the user elected to participate in the media activity.

If, at step 708, the collaboration session object determines that the user elects to participate in the media activity, then, at step 710, the collaboration session object creates an activity object for the media description, and ends processing. The collaboration session object may send an SDP message informing of the successful creation of the media activity and the user's willingness to participate in the activity. In some embodiments, the collaboration session object may update the roster for the activity to include the user as a participant.

If, at step 708, the collaboration session object determines that the user elects not to participate in the media activity, then, at step 712, the collaboration session object provides an appropriate error notification, and ends processing. For example, the collaboration session object may send an SDP message informing of the user's desire not to participate in the requested media.

The following are examples of some APIs provided by the base collaboration session in some embodiments.

A CollaborationSession method creates a new collaboration session using the CEP. The method accepts the following parameters: a collaboration endpoint; a subject for the created session; and an id for the session.

A CollaborationEndpoint method requests the collaboration endpoint, and provides the value of the collaboration endpoint.

A SessionIdentity method requests the unique identity for the collaboration session, and provides the identity value.

A Subject method requests the subject of the current collaboration session, and provides a string specifying the subject of the session.

An Activities method requests the list of collaboration session activities, and provides the list of active activities.

A Participants method requests the dynamic list of collaboration session participants, and provides the collection of collaboration participants. The list does not include the local participants. The collection is a keyed collection and provides additional methods to look up participants by id.

A State method requests the state of the collaboration session, and provides an indication of the state.

A CanInvite method checks to determine if it is possible to invite new participants, and provides an indication of success (positive) or failure (negative). The method accepts as a parameter a target to test for invite. A positive answer indicates that it is possible to invite the new participant, but is not a guarantee of success. A negative answer implies that it is not possible to invite.

An Accept method accepts an incoming session, and is called before using an incoming session.

Conversely, a Decline method declines an incoming session.

An Enter method enters the session, and is called to participate in the session created by the application. This method can be called when the state of the session is “Idle.” If the operation is successful, the state can transition to “Connected.” This is the first method an application should call before using the session.

An Invite method invites a new participant into the session, and accepts as a parameter a target session. If the invitation succeeds, the participant might show up not only in the roster of the session, but also in one or more of the activities.

A Leave method leaves a session, and the session can no longer be used.

A Forward method forwards the session to the target specified, and accepts as a parameter a target to forward the session to.

The following are examples of some APIs provided by the base activity class in some embodiments.

An Activity method initializes a new instance of the Activity class, and accepts as parameters the collaboration session and the identity for this activity. This method creates an instance of the activity in the collaboration session. The method is normally used for incoming activity.

A ConfigurationComplete method is called when the subclass has finished configuring the base class.

A SetModePreferences method sets the modes the activity wishes to operate in, and accepts as a parameter the mode preferences for the activity.

A ModePreferences method requests the currently configured list of mode preferences, and provides the configured mode preferences on the activity.

A SetMessageReceivedHandler method allows configuration of the MessageReceived handler by subclass, and accepts as a parameter the handler for receiving messages.

A SetGetMediaOfferHandler method allows configuration of the get offer handler by subclasses, and accepts as a parameter the delegate to use for GetMediaOffer method.

A SetGetMediaAnswerHandler method allows configuration of the get offer handler by subclasses, and accepts as a parameter the delegate to use for GetMediaAnswer method.

A SetMediaAnswerHandler method allows configuration of the get offer handler by subclasses, and accepts as a parameter the delegate to call for SetMediaAnswer method.

A CollaborationSession method requests the collaboration session, and provides an indication of the collaboration session.

A StateChanged event is raised whenever the state of the activity changes.

An Id method requests the id of the activity, and provides the Id value of the activity.

A State method requests the state of the signaling plane of the activity, and provides the current state of the signaling plane.

An ActivityMode method requests the activity negotiation mode, and provides an indication of the media negotiation mode.

A CollaborationParticipants method requests the collection of activity participants, and provides the collection of activity participants. The provided URI+epid serves as the key into the collection. The participant instances are different from those of collaboration session.

An Enter method enters the activity. The activity is entered before it can be used.

Conversely, a Decline method rejects the activity.

A Leave method leaves the activity.

A Renegotiate method renegotiates media negotiation with the remote node, and is the appropriate method to be called by an activity with MediaNegotiationMode as McuClient.

A Renegotiate method renegotiates media description with the participant specified, and accepts as a parameter the participant with whom the negotiation is needed. This is the appropriate method to be called by an activity with MediaNegotiationMode as McuServer or PeerToPeer.

A SendMessage method sends a message and is provided for sending simple media data through the signaling plane, and provides an asynchronous indication of the results of the send operation. The method accepts as parameters the following: the type of sip message to send; the content type describing the body; the body for the data; the delegate to call for reporting failure status; the delegate to call for reporting success status; and the delegate to call for reporting pending status.

In other embodiments, the API for both the base collaboration session and base activity class may provide a Participate method and a Terminate method instead of the Accept, Decline, and Enter methods. The Participate method accepts or enters an incoming session or newly created session. The Terminate method declines or leaves an existing session.

The methods are only an illustrative sample and may be provided by various components/objects of the architecture. The architecture may additionally provide various other method, properties, and events related to (1) facilitating the extensibility of activities; (2) providing ease of implementing a new activity by depending on the base activity class; and (3) providing an application the benefit of using the base activity across all activities and the same collaboration session.

From the foregoing, it will be appreciated that embodiments of the invention have been described herein for purposes of illustration, but that various modifications may be made without deviating from the spirit and scope of the invention. Accordingly, the invention is not limited except in accordance with elements explicitly recited in the appended claims.

We claim:

1. One or more computer memories collectively comprising an architecture for an extensible collaboration session, the architecture comprising:
a base collaboration session being operable to provide session management services, and operable to be replicated to create multiple collaboration session objects, wherein each collaboration session object being operable to serve as a container for one or more activity objects;
a base activity class being operable to provide a facility for developing activities derived from the base activity class, and operable to serve as an interface to the base collaboration session; and
a well defined contract between the base collaboration session and the base activity class,
wherein the base activity class provides an application program interface suitable for use by applications to develop activities derived from the base activity class, and further wherein an activity object can be added to a collaboration session object.

2. The computer memories of claim 1, wherein the base collaboration session being further operable to provide media negotiation.

3. The computer memories of claim 1, wherein the base collaboration session being further operable to provide a roster of participants in a collaboration session object.

4. The computer memories of claim 1, wherein the base collaboration session having specific knowledge of activities that may be supported in a collaboration session object.

5. The computer memories of claim 1, wherein the base activity class being further operable to provide a roster of participants participating in a derived activity object.

6. The computer memories of claim 1 further comprising a collaboration session endpoint being operable to create collaboration session objects.

7. One or more data signals that collectively convey an extensible collaboration session data structure, the data structure comprising:
a base collaboration session being operable to providing signaling plane functionality, and operable to be replicated to create multiple collaboration session objects, wherein each collaboration session object being operable to serve as a container for one or more activity objects; and
a base activity class being operable to provide base class support for developing derived activities, and operable to serve as an interface to the base collaboration session, wherein a derived activity provides media plane functionality,
such that base collaboration session and the base activity class provide a bridge that enables the signaling plane and the media plane to exchange well defined data.

8. The data signals of claim 7, wherein the well defined data is exchanged through application program interfaces.

9. The data signals of claim 7, wherein the base collaboration session and the base activity class function to hide the details of the signaling plane from the derived activities.

10. The data signals of claim 7, wherein a collaboration session object is operable to create a derived activity object.

11. The data signals of claim 7, wherein the base activity class being further operable to provide a list of participants involved in the signaling plane for a derived activity.

12. The data signals of claim 7, wherein the base activity class being further operable to receive a registration of delegates for a derived activity, wherein the delegates being operable to handle media negotiation.

13. The data signals of claim 7, wherein the base activity class being further operable to receive an indication of a preference order of the signaling topology for a derived activity.

14. A computer-readable storage medium whose contents cause a computer to:
instantiate an instance of a collaboration endpoint;
within the collaboration endpoint instance:
receive an invitation to participate in a session from a remote endpoint, the invitation comprising a media description of an activity;
determine whether a collaboration session object corresponding to the session currently exists;
create a collaboration session object corresponding to the session in response to determining that a collaboration session object that corresponds to the session does not currently exist; and
pass the invitation to the collaboration session object corresponding to the session for processing,
wherein the collaboration session object being operable to contain at least one activity object corresponding to an instance of an activity derived from a base activity class, and operable to provide signaling plane functionality to activity objects contained in the collaboration session object.

15. The computer-readable storage medium of claim 14 further comprising computer instructions that, when executed by a computer, cause the computer to, within the collaboration session object:
determine whether a registered activity corresponds to the activity described by the media description; and
responsive to determining that a registered activity corresponds to the activity, instantiate an instance of the registered activity corresponding to the activity within the collaboration session object, wherein the registered activity is derived from a base activity class, the base activity class operable to serve as an interface to the collaboration session object.

16. The computer-readable storage medium of claim 15, wherein the activity instance is instantiated in response to receiving an indication from a user of the user's willingness to participate in the activity.

17. The computer-readable storage medium of claim 15, wherein the activity instance provides media plane functionality.

18. The computer-readable storage medium of claim 15, wherein the collaboration session object being further operable to instantiate an instance of a second registered activity corresponding to a second activity within the collaboration session object, the second activity described by a second media description.

19. The computer-readable storage medium of claim 14, wherein the collaboration session object being operable to conduct a multi-party session.

20. The computer-readable storage medium of claim 14, wherein the collaboration session object being operable to conduct a multi-modal session.
